(19) United States
(12) Patent Application Publication
(10) Pub. No.: US 2009/0166144 A1
(43) Pub. Date: Jul. 2, 2009

(54) Friction system

(75) Inventors: Tim-Florian Gerbing, Betzdorf (DE); Christian Spandern, Elkenroth (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/321,330

(22) Filed: Jan. 20, 2009

Related U.S. Application Data
(63) Continuation of application No. PCT/DE2007/001150, filed on Jun. 28, 2007.

(30) Foreign Application Priority Data
Jul. 21, 2006 (DE) 10 2006 033 739.5

(51) Int. Cl. F16D 13/60; B29C 43/00

(52) U.S. Cl. 192/107 M; 264/331.11

(57) ABSTRACT

A friction system, including a plurality of friction elements which interact by way of contact surfaces for clutches of gearboxes or wheel brakes of motor vehicles. At least one friction element from the plurality of friction elements includes wholly or in part a composite material with high wear resistance and high heat resistance. The at least one friction element includes a carbonized plastics matrix mixed with frictionally active substances and strengthening fibers and a high-temperature-resistant friction matrix with stable friction properties and high wear resistance.

The invention relates to a friction system, comprising at least two friction elements which interact by way of contact surfaces, preferably for clutches of gearboxes and/or wheel brakes of motor vehicles.

The transmission of torques in high-performance internal combustion engines to motor vehicle gearboxes requires the clutches developed for the purpose to be provided with above all temperature- and wear-resistant friction elements. Composite materials of various types are used for these friction elements. Similar materials are also used for the friction elements of wheel brakes for motor vehicles, in order to improve braking power while reducing the weight of brake discs acting as friction elements.

It is known to use high-performance materials for friction discs of clutches for motor vehicle gearboxes and wheel brakes, as described for example in DE 44 38 456 A1. These friction discs comprise friction surfaces which are formed of a carbon-fiber-reinforced, porous carbon body, the pores of which are at least partially filled with silicon carbide. Said friction discs comprise at least one core member and at least one friction member joined thereto. The two are joined together on a side remote from a friction surface of the respective friction disc and fastened together by means of a high-temperature-resistant bonding layer.

DE 101 56 947 A1 relates to a clutch between an internal combustion engine and a gearbox, which clutch is designed such that it transmits high torques while having spatially favorable dimensions and exhibiting relatively low wear. In this case, friction elements are used which substantially comprise the following constituents: brass, iron, copper, aluminum, a silicon-rich phase, a sulfur-rich phase, carbon and phenolic resin binder. These friction elements have a high coefficient of friction and high thermal stability.

EP 1 277 715 B1 relates to a multilayer ceramic composite, which contains at least one composite material forming a supporting zone. The latter has oxidation-sensitive reinforcing fibers and at least one ceramic outer layer. The invention disclosed in this cited industrial property right provides ceramic composites which are suitable as brake and clutch discs for motor vehicles.

It is the object of the invention to provide a friction system with at least one friction element which is suitable for use in clutches and wheel brakes of motor vehicles and is distinguished by wear resistance, temperature resistance and stable friction properties.

According to the invention, this object is achieved by the features of claim 1. In addition, features further developing the invention are contained in the following claims.

The advantages principally achieved with the invention are that the friction element of the friction system is distinguished by high wear- and temperature-resistance and stable friction properties as a result of the raw materials used, processing to yield a preform, subsequent carbonization by pyrolysis and final machining. This friction element is therefore extremely well suited to withstanding demanding service loads in the case of clutches, in particular twin clutches between motor vehicle internal combustion engine and gearbox. However, use of the friction element also suggests itself when it comes to wheel brakes in particular of high performance motor vehicles due to its exemplary material composition and production or machining method. The individual raw materials used for the friction element to be produced are available and may be converted straightforwardly into a preform or green compact by suitable manufacturing technologies—mixing, press molding and curing. The final temperature resistance, wear capacity and stable friction properties of the friction element are achieved by carbonization of the preform by means of pyrolysis. Pyrolysis denotes thermal cleavage of chemical compounds, bond breakage being forced to take place within large molecules due to high temperatures. This takes place with the exclusion of oxygen, so as to prevent combustion. The method features of claims 11 to 22 are suitable for producing the friction element of the friction system with its advantageous properties.

The drawings show exemplary embodiments of the invention, which are described below in greater detail.

In the drawings

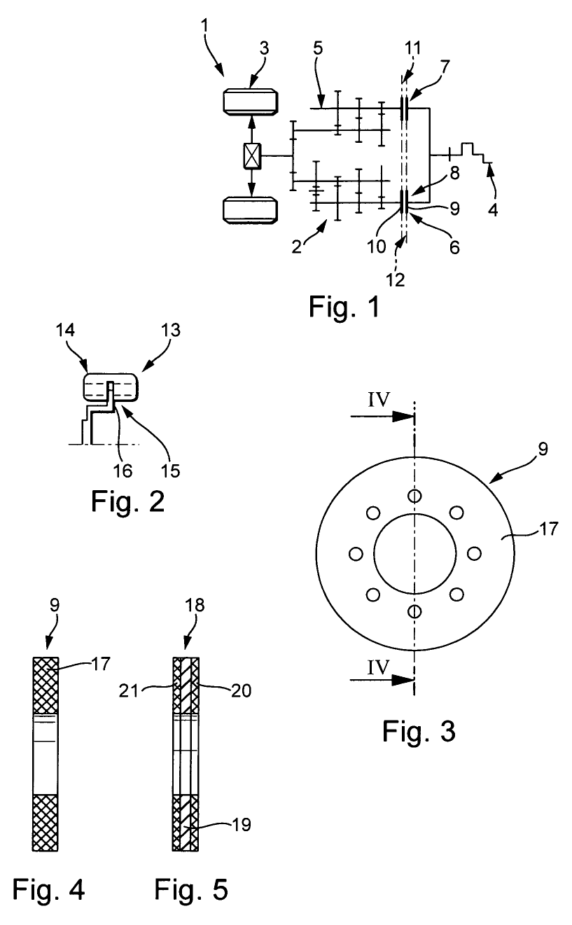

FIG. 1 is a schematic view from above of a motor vehicle with an internal combustion engine and a gearbox, between which there acts a twin clutch comprising friction systems,

FIG. 2 shows a schematic wheel brake with a friction system,

FIG. 3 shows a friction element of a friction system,

FIG. 4 shows a section along line IV-IV of FIG. 3,

FIG. 5 shows a view corresponding to FIG. 4,

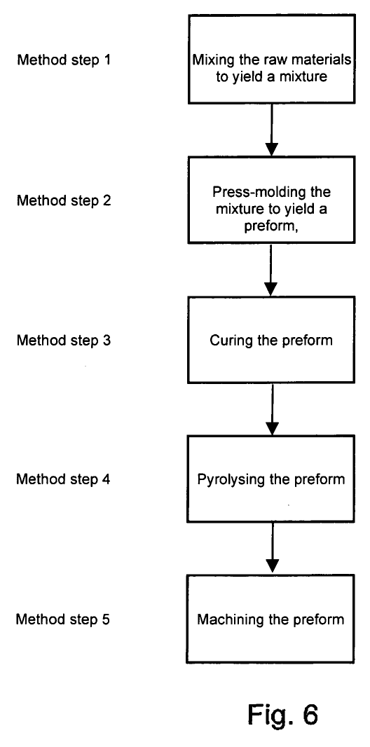

FIG. 6 is a flow chart of a production process for a friction element.

A motor vehicle 1 is driven by means of a drive unit 2 via wheels 3—FIG. 1. The drive unit 2 comprises an internal combustion engine 4 and a gearbox 5, which takes the form of a twin-clutch gearbox and has a first clutch 6 and a second clutch 7. Each clutch, for example 6, takes the form of a dry clutch and is provided with a friction system 8, which comprises friction elements 9 and 10 in active connection with one another. The friction elements 9 and 10 act on mutually facing contact surfaces 11 and 12.

FIG. 2 shows a wheel brake 13, which consists of a brake caliper 14 and at least one friction element 15. The brake caliper 14 encompasses a brake disc formed by a friction element 16.

Since the friction elements 9, 10 and 15 are similar in function, only the friction element 9 will continue to be referred to below. The friction element 9 is produced by carbonizing a plastics matrix mixed with frictionally active substances and strengthening fibers with the exclusion of oxygen and producing a high-temperature-resistant friction matrix with stable friction properties and high wear resistance. The friction element 9 (FIG. 3, FIG. 4) is a type of rotationally symmetrical annular disc 17, which is produced according to FIG. 4 from one piece. In contrast, in FIG. 5 the annular disc 18 is of multipart construction and comprises a core disc 19, which is bounded by friction elements 20 and 21. The friction elements 20 and 21 are constructed from the point of view of materials to a certain extent in the same way as the friction element 9 and joined to the core disc using suitable measures.

The following raw materials are used to produce the friction element 9: resin, for example Novolak powder resin, barytes (barium sulfate), lamp black, PAN (polyacrylonitrile) fibers, glass fibers and bronze. These raw materials have the following functions:

| Raw material | Function |
|---|---|
| Novolak powder resin | provides strength |
| Barytes (barium sulfate) | stabilizes coefficient of friction |
| | (surface modifier) |
| Lamp black | increases material stability, modifies |
| | coefficient of friction (lubricant) |
| Preoxidized PAN fibers | increase material stability, modify |
| | coefficient of friction |
| Glass fibers for example 3 mm | increase material stability, modify |
| | coefficient of friction |
| Bronze powder | modifies coefficient of friction |
| | (adhesive friction) |

The constituents of the raw materials for producing the friction element are divided up as follows:

| | |
|---|---|
| Novolak powder resin | 20 vol. % |
| Barytes | 20 vol. % |
| Lamp black | 15 vol. % |
| Preoxidized PAN fibers | 15 vol. % |
| Glass fibers | 15 vol. % |
| Bronze powder | 15 vol. % |

The glass fibers may be between 1 mm and 5 mm in length, wherein a length of 3 mm is particularly suitable.

A method having the following steps is suitable for production:

1. Processing the constituents to yield a homogeneous mixture.

2. Processing the mixture with a suitable resin content using a defined press molding method to yield a preform.

3. Precuring the preform during the press molding procedure.

4. The temperature during the press molding procedure amounts to between 120° C. and 180° C., preferably 150° C.

5. The preform is treated using a curing process.

6. The preform curing process proceeds at temperatures of between 220° C. and 280° C., preferably 250° C.

7. The preform is treated by carbonization.

8. The preform is carbonized by pyrolysis.

9. Pyrolysis of the preform takes place from 350° C. in an inert atmosphere.

10. Pyrolysis of the preform takes place at temperatures in the range from 400° C. to 600° C., the resin, preferably phenolic resin, being converted into carbon.

11. The friction element treated by pyrolysis is finished by defined machining for example stamping, cutting, drilling, grinding or the like.

FIG. 6 represents production of the friction element in the form of five steps, in which the procedure is as follows:

1. Mixing the raw materials using a suitable mixing means to yield a mixture,

2. Press-molding the mixture using a suitable press-molding method to yield a preform,

3. Curing the preform for example in a forced air chamber kiln,

4. Pyrolysing the preform,

5. Machining the friction element produced for example by means of stamping, cutting, drilling, grinding or the like.

1. A friction system, comprising at least two friction elements which interact by way of contact surfaces, preferably for clutches of gearboxes and/or wheel brakes of motor vehicles, of which at least one friction element consists wholly or in part of a composite material with high wear resistance and high heat resistance, wherein the friction element (9, 10, 15, 20, 21) is produced by carbonizing a plastics matrix mixed with frictionally active substances and strengthening fibers with the exclusion of oxygen and producing a high-temperature-resistant friction matrix with stable friction properties and high wear resistance.

2. The friction system as claimed in claim 1, wherein the friction element (9) takes the form of a type of annular disc (16).

3. The friction system as claimed in claims 1 and 2, wherein the friction element (9) of the annular disc (17) is produced from one piece.

4. The friction system as claimed in claims 1 and 2, wherein the friction system of the annular disc (18) comprises a core disc (19) with friction elements (20, 21) attached thereto.

5. The friction system as claimed in claim 1, wherein substantially the following raw materials are used to produce the friction element (9, 10, 15, 20, 21):
resin
barytes
lamp black
preoxidized PAN fibers
glass fibers

6. The friction system as claimed in claims 1 and 5, wherein bronze powder is used to produce the friction element.

7. The friction system as claimed in one or more of the preceding claims, wherein substantially the following raw materials are used to produce the friction element:
resin
barytes
lamp black
preoxidized PAN fibers
glass fibers
bronze powder

8. The friction system as claimed in claim 7, wherein Novolak powder resin is used as the resin.

9. The friction system as claimed in one or more of the preceding claims, wherein the raw materials as constituents for producing the friction element are divided up as follows:

| | |
|---|---|
| Novolak powder resin | approx. 20 vol. % |
| Barytes | approx. 20 vol. % |
| Lamp black | approx. 15 vol. % |
| Preoxidized PAN fibers | approx. 15 vol. % |
| Glass fibers | approx. 15 vol. % |
| Bronze powder | approx. 15 vol. % |

10. The friction system as claimed in claim 9, wherein the glass fibers are 1 to 3 mm, preferably 3 mm, in length.

11. A method of producing the friction element as claimed in one or more of the preceding claims, wherein the constituents are processed to yield a homogeneous mixture.

12. The method as claimed in claim 11, wherein the mixture with a suitable resin content is processed to yield a preform in a press tool using a defined press-molding method.

13. The method as claimed in claim 12, wherein the preform is precured during the press-molding procedure.

14. The method as claimed in claim 12, wherein the temperature during the press-molding procedure amounts to between 120° C. and 180° C., preferably 150° C.

15. The method as claimed in one or more of the preceding claims, wherein the preform is treated by means of a curing process.

16. The method as claimed in claim 15, wherein the curing process for the preform proceeds at temperatures of between 220° C. and 280° C., preferably 250° C.

17. The method as claimed in one or more of the preceding claims, wherein the preform is treated by means of carbonization.

18. The method as claimed in claim 17, wherein carbonization of the preform takes place by pyrolysis.

19. The method as claimed in claim 18, wherein pyrolysis takes place from 350° C. in an inert atmosphere.

20. The method as claimed in claims 18 and 19, wherein pyrolysis takes place at temperatures in the range from 400° C. to 600° C. and brings about conversion of the resin, preferably phenolic resin, into carbon.

21. The method as claimed in one or more of the preceding claims, wherein the friction element treated using pyrolysis is finished by defined machining, e.g. drilling, grinding or the like.

22. The method of producing the friction element as claimed in claims 1 to 8, characterized by the following method steps,
Bringing together the raw materials into a mixture using a suitable mixing means,
Metering and press-molding the mixture to yield a preform using a suitable press-molding method,
Curing the preform in a forced air chamber kiln,
Pyrolysing the preform,
Machining the friction element produced e.g. by means of stamping, cutting, drilling, grinding or the like.
